(19) United States
(12) Patent Application Publication
(10) Pub. No.: US 2023/0192425 A1
(43) Pub. Date: Jun. 22, 2023

(54) APPARATUS AND METHOD FOR UNLOADING AND LOADING A TRANSPORT UNIT

(71) Applicant: Simec Systems Oy, Oitti (FI)

(72) Inventor: Simo Aitto-Oja, Oitti (FI)

(21) Appl. No.: 17/553,936

(22) Filed: Dec. 17, 2021

(51) Int. Cl. B65G 67/02; B66F 9/075; B66F 9/14

(52) U.S. Cl. CPC B65G 67/02; B66F 9/07572; B66F 9/142

(57) ABSTRACT

According to an example aspect of the present invention, there is provided an apparatus or method unloading and loading containers, trucks and other similar transport units (1). Especially the apparatus and method are suitable for handling pallets (4). The apparatus comprises a pair or more forklift forks (17) or another type of a handling element, for example a gripper for handling rolls or specially formed spikes. The handling elements are mounted on a carriage (16) that is mounted on a frame (15). The frame (159 runs on wheels (17) or tracks on the floor (2) of the transport unit (1). The apparatus uses a telescopic arm (3) for moving the apparatus on the wheels (17) or tracks on the floor (2). The apparatus can be pushed into the transport unit (1) and runs on the floor (2). A load is picked by the handling elements and withdrawn with the telescopic arm (3).

### FIELD

The invention concerns an apparatus and method for moving palletized loads, for example from and to a transport vehicle. In addition, the invention relates to goods handing systems utilizing the apparatus and method.

### BACKGROUND

The transfer of palletized loads requires durable and reliable equipment. Low investment costs and small footprint are further desirable features. Various loading methods and mechanisms have been developed for the transfer of palletized goods. Typically, the loads are moved to the container or transport platform by a forklift or other goods handling equipment. In addition to forklifts, means are needed to transfer the load from outside the means of transport to the means of transport carrying the load, such as a container, trailer or train. A trailer of a truck can be loaded and unloaded with a forklift or by a pallet jack. This is slow, but frequently used, especially for larger goods. In addition, in order to prevent damage to the trailer or container or in order to support a single or few pieces of goods, a pallet may be used in each truck-mounted load unit. Pallets are mainly used for collecting smaller goods or packages to larger palletized units for transport or to support the goods during transport. They offer standardized sized load or package and a sturdy support for handling and transport. In modern logistics, loading and unloading time of transport vehicles like trucks or trains should be minimized. Therefore, it would be advantageous to collect a load dimensioned for a container or a truck bed in advance and move it as a single unit to the container or other transport unit. The containers are closed spaces having limited room for movement, whereby only relatively small forklifts can be used for loading and unloading them. The floors of the truck beds and containers can withstand only limited amounts of centralized, point loads except where supported by the frame. This may limit the combined weight of the loading forklift and load that can be allowed.

One way to unload and load a container space or a vehicle is a telehandler comprising a telescopic reach arm and lift forks for lifting a pallet. One such apparatus is described in CN 206051458. Telehandlers are available from MANITOU and LIEBHERR, for example. Publications CN108017021 and CN106957033 disclose examples of different types of pallet handling devices.

### SUMMARY OF THE INVENTION

The invention is defined by the features of the independent claims. Some specific embodiments are defined in the dependent claims.

According to a first aspect of the present invention, there is provided an apparatus for unloading/loading a transport unit, comprising a frame, a carriage mounted on the frame and load handling elements for lifting a load. A rolling support is mounted on the frame, the rolling support being configured to provide rolling support for the frame on two locations spaced apart from each other.

According to a second aspect of the present invention, there is provided a method for unloading and loading a transport unit, wherein an unloading/loading apparatus is forwarded into a transport unit supported by a rolling support providing rolling support on two locations spaced apart from each other, lifting the load with elements for lifting the load of the unloading/loading apparatus and withdrawing the load supported by the rolling support.

Further aspects of the invention include features described in the following list. Each of these features may be included in one or more embodiments of the invention.
an actuator is attached to the frame for providing a linear movement for the apparatus,
elements for lifting the load are at least two forks mounted adjustably on the carriage so that the locations of the forks on the carriage are adjustable,
the rolling support comprises wheels,
the rolling support comprises caterpillar tracks or a belt,
the wheels, tracks or belts are operated by and actuator for providing traction,
the forks are adjustable hydraulically, pneumatically or electrically,
the forks are telescopic,
forks comprise a hinge configured to enable tilting of forks upwards towards the carriage,
the load is lifted by hoisting or tilting the elements for lifting the load,
the actuator for providing the linear movement is a telescopic arm,
the telescopic arm is mounted on a support frame that is movable at least in direction sideways to direction of movement of the telescopic arm,
the telescopic arm is mounted on a support frame that is rotatable around a mounting point,
the telescopic arm is a telescopic arm of a telehandler,
the carriage is mounted on the frame by a mast comprising a lift actuator for raising and lowering the carriage,
the mounting position of the telescopic arm forms a first reference point, a unloading/loading dock is positioned in the direction of the movement of the telescopic arm and a transporter is positioned between the first reference point and the unloading/loading dock,
a transporter is positioned on side of the first reference point,
a transporter is positioned on opposite side of the first reference point in view of the unloading/loading dock,
the apparatus comprises side guides.
a pillar frame on which the telescopic arm is mounted and a transporter set between the pillars of the pillar frame.

### BRIEF DESCRIPTION OF THE DRAWINGS

FIG. 1 illustrates as an overview an unloading/loading apparatus in accordance with at least some embodiments of the present invention;

FIG. 2 is an enlarged detail of FIG. 1:

FIG. 3 is an enlarged detail of FIG. 2;

FIGS. 4-6 show the apparatus of FIG. 1 in three different operating positions:

FIGS. 7 and 8 illustrate an apparatus in accordance with at least some embodiments of the present invention in two different operating positions;

FIG. 9 illustrates as an overview an unloading/loading apparatus in accordance with at least some embodiments of the present invention;

FIGS. 10-12 show the apparatus of FIG. 9 in three different operating positions;

FIGS. 13 and 14 illustrate as an overview an unloading/loading apparatus in accordance with at least some embodiments of the present invention in two operating positions;

FIG. 15 shows the apparatus of FIGS. 13 and 14 seen in the direction of a transport unit;

FIG. 16 shows the apparatus of FIG. 13 and in a side view;

FIG. 17 illustrates as an overview an unloading/loading apparatus in accordance with at least some embodiments of the present invention;

FIG. 18 is an enlarged detail of FIG. 17:

FIG. 19 is an enlarged detail of FIG. 18;

### EMBODIMENTS

### Definitions

In the present context, the term “pallet” comprises standardized pallets and other loading trays or platforms that can be lifted and moved by forks like the ones used in forklifts.

The term “transport unit” depicts devices designed for carrying a load of goods and includes but is not limited to container, train wagons, truck beds or shipping platforms.

The invention relates to unloading and loading containers, trucks and other similar transport units. Especially the apparatus and method are suitable for handling pallets. The apparatus comprises a pair or more forklift forks or another type of an handling element, for example a gripper for handling rolls or specially formed spikes. The handling elements are mounted on a carriage that is mounted on a frame. The frame runs on wheels or tracks on the floor of the transport unit. The apparatus uses a telescopic arm for moving the apparatus on the wheels or tracks on the floor. The apparatus can be pushed into the transport unit and runs on the floor. A load is picked by the handling elements and withdrawn with the telescopic arm. As the load is carried by the wheels or tracks, only compressive and pulling forces are directed to the telescopic arm making a lightweight construction possible. Several operation modes and variations are provided for unloading, loading and handling the goods after unloading or before loading.

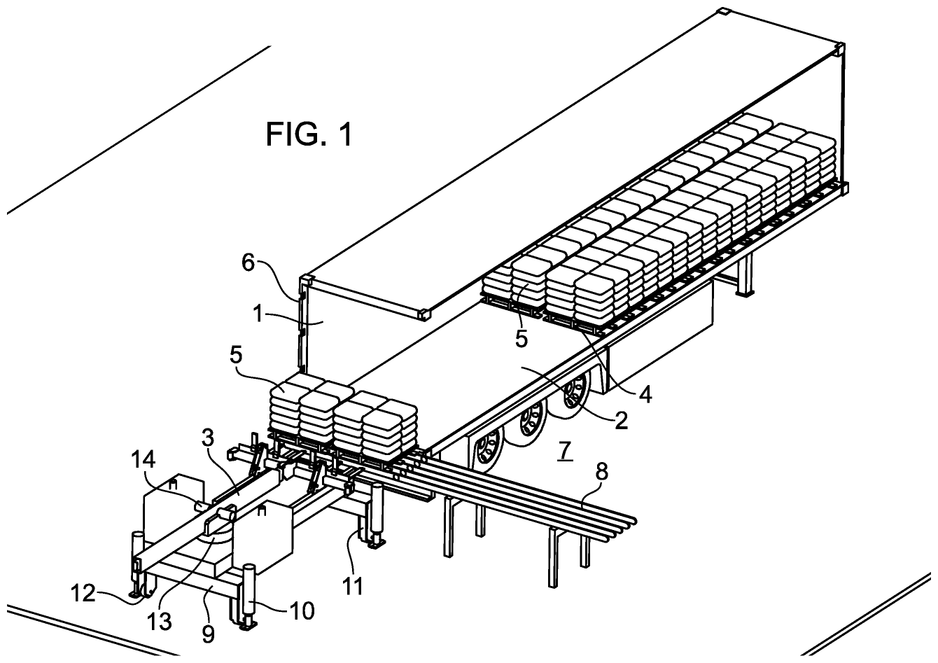

FIG. 1 illustrates an unloading/loading apparatus in accordance with at least some embodiments of the present invention. Herein the transport space 1 is a trailer having closed walls (one wall removed for illustration). This apparatus is for handling pallets 4. The transported goods 5 are loaded on the pallets 4. The pallets rest on the floor of the trailer 1. The trailer is parked on an unloading/loading dock 7 having a transverse transporter 8 on side of which the trailer is reversed so that the open back end of the trailed is against the transverse transporter 8. The unloading/loading apparatus of FIG. 1 comprises a chassis 9. The chassis 9 has four legs 11. The legs 11 include transport wheels 12 for moving the apparatus and adjustment cylinders 10 for setting the height of the apparatus. The adjustment cylinders 10 may be hydraulic, pneumatic or electric, for example. A telescopic arm 3 is mounted on the chassis 9 via a support frame 3. The support frame includes a tilt axle 14 connecting the telescopic arm 3 to the support frame 13. The purpose of the tilt axle 14 is to allow adjustment of the height of the extending end of the telescopic arm 3.

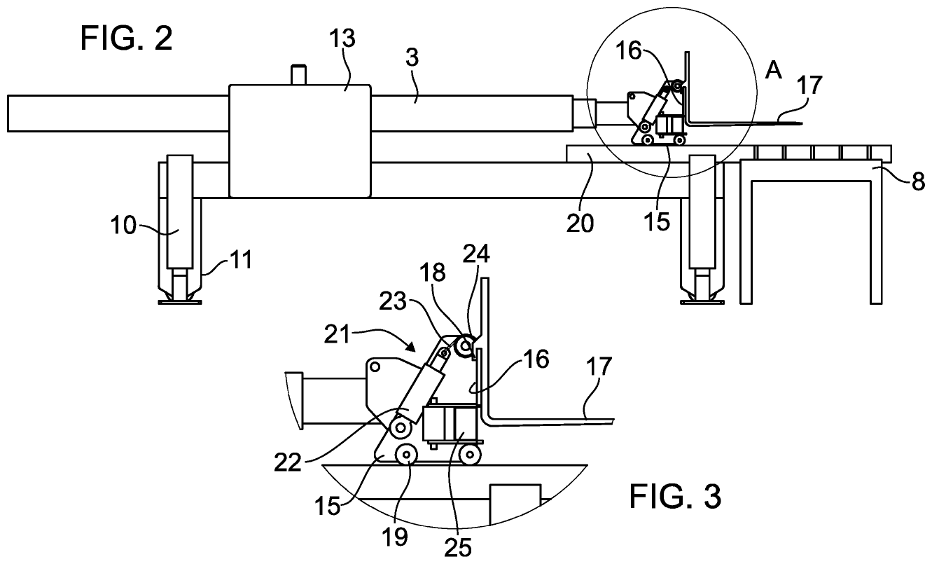

At the extending end of the telescopic arm 8 are elements for picking up and moving the pallets 4. These elements are shown in FIGS. 2 and 3. They comprise a frame 15 connected to the extending end of the telescopic arm 3 and a carriage 16, on which a set of forks 17 are mounted. The forks 17 are standard forklift forks. The carriage 16 is a simple steel plate on which the forks 17 are hanged, for example by hooks 18. The carriage preferably has locking slots for keeping the forks 17 in place. Adjustment of the position of the forks may be done manually, or if a frequent adjustment is needed, an adjustments system operating electrically, pneumatically or hydraulically may be provided. The frame has set of wheels 19 on which it is configured to run. There are two wheel sets in the frame connected by a cross beam of the frame 15. The wheels may be any type of wheels, rollers or even skis may be used or, for example when larger footprint is needed to avoid high areal loads, even a caterpillar track or a belt can be used. The wheels 19 run on a rail 20 extending over the transverse transporter 8. In this example, two set of wheels are used, but if needed, for example for lowering surface pressure on the floor, more wheel sets can be added. The transverse transporter may be of any kind of a transporter, as long it is capable of carrying and moving the loads on pallets. One example is a simple roller table. A lifting mechanism 21 is provided for lifting and lowering the forks 17. In this example, the lifting mechanism comprises an operating cylinder 22 attached to the frame at one end and having a wire or chain 23 attached on the other end. The chain 23 travels over a pulley 24 to the carriage 16. Now, when the operating cylinder 22 is contracted, the carriage 16 is lifted, raising the forks 17. When the operating cylinder is extended, the carriage and forks are lowered. Alternatively the carriage can be operated by a cylinder (hydraulic or pneumatic) or by an electrical actuator directly. One further feature the frame 16 includes is guide rollers 25 mounted on each side of the frame 15. These are for preventing jamming of the apparatus on the walls 6 of the transport unit 1 and to protect said walls. The rollers may be replaced with guide plates or rails.

The apparatus described above is movable on transport wheels 12. When unloading/loading is needed, it is moved to a desired handling point and set on a suitable height by operating the adjustment cylinders 10. The rails 20 should extend to edge of the transport unit 1 relatively on same level as the floor 2 of the transport unit 1. A slight difference may be allowed as wheels 19 of the frame 15 accommodate some unevenness on the running surface. The tilt axle 14 is provide for the same purpose. One can also contemplate that some of the gaps are covered permanently or temporarily by cover plates. If the transport unit has pneumatic suspension, it rises and lower according to the weight of the load, whereby some setting by adjustment cylinders during unloading/loading may be required.

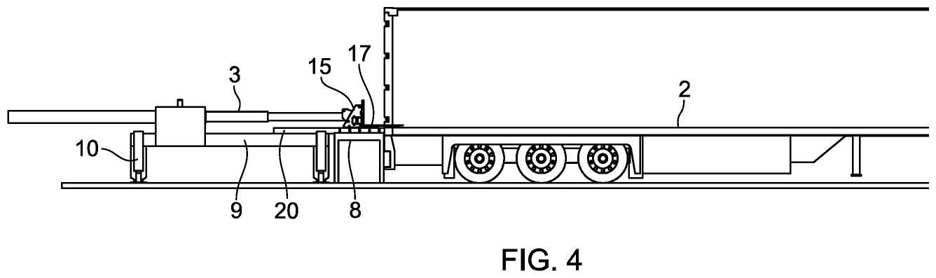

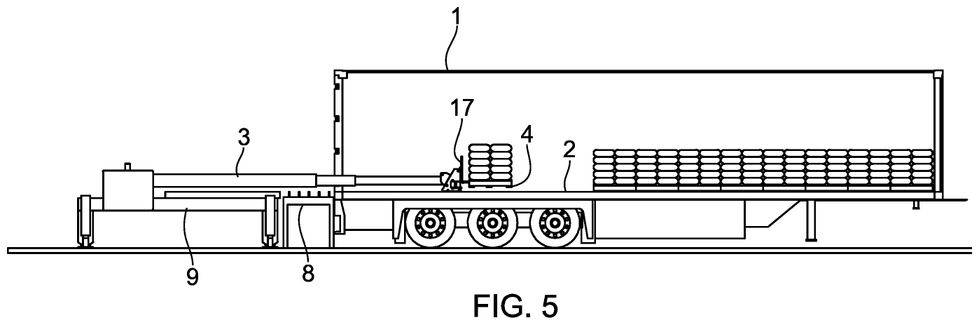

As can be seen from FIG. 1, the apparatus described herein is designed for unloading/loading two parallel pallets. Thus, at least four forks 17 are needed, two for each pallet 4. In FIG. 1 a unloading cycle is in stage where pallets are set on the transvers conveyor for transporting forward to a next location. The telescopic arm 3 is retracted. In FIG. 4 the telescopic arm 3 is extended so that the wheels 19 run on the rails 20 and forks 17 extend to the transfer unit 1. In FIG. 5 a set of pallets 4 has been picked and is being transferred out from the transfer unit 1 by retracting the telescopic arm 3. Picking of the pallets 4 is performed by pushing the forks under the pallets 4 in a normal way. Thereafter the pallets 4 are lifted by operating the operation cylinder 22. Now, as the load is supported on wheels 19, the telescopic arm 3 doesn't carry much load. Only a momentum needed to keep the frame straight is needed to be compensated. Otherwise, only pulling force is directed to the telescopic arm 3, whereby it may be lightweight, and therefore easy and less inexpensive to manufacture. The track distance of the wheels 19 should be chosen so that they run on the parts of the floor 2 having trailer frame (or container frame) support underneath as the floor itself may not withstand high concentrated surface loads.

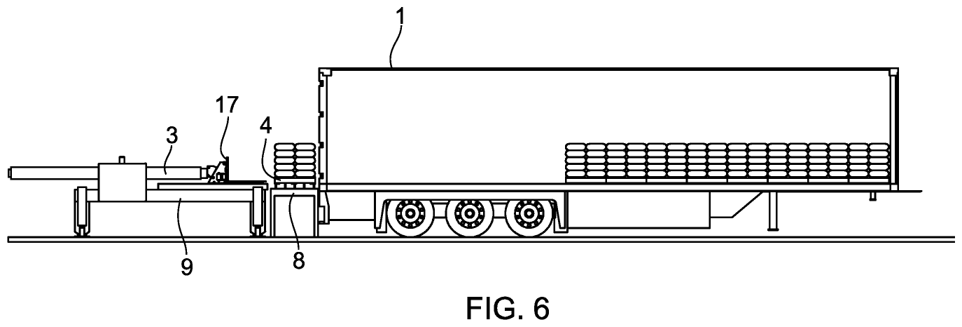

On FIG. 6 the pallets 4 are set on the transverse transporter 8.

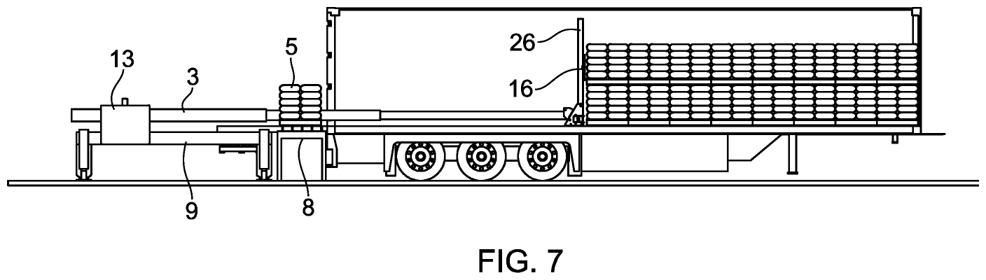

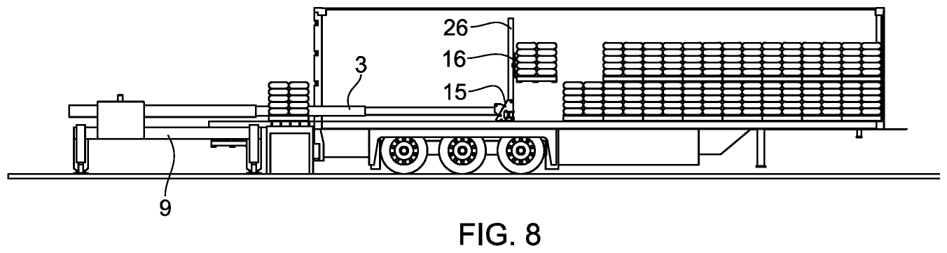

FIGS. 7 and 8 illustrate another type of apparatus for unloading/loading. In this type the carriage 16 is mounted on the frame via a mast 26. The mast 26 includes rails and a lift cylinder for lifting and lowering the carriage 16 and forks 17. As can be seen from FIG. 8, this apparatus can be used for picking up a pallet 4 placed on other loaded pallets of goods 5 providing a more flexible operation mode when stacked goods are handled. The mast and fork structure is basically the same as in forklifts and parts of forklifts may be used for constructing this apparatus.

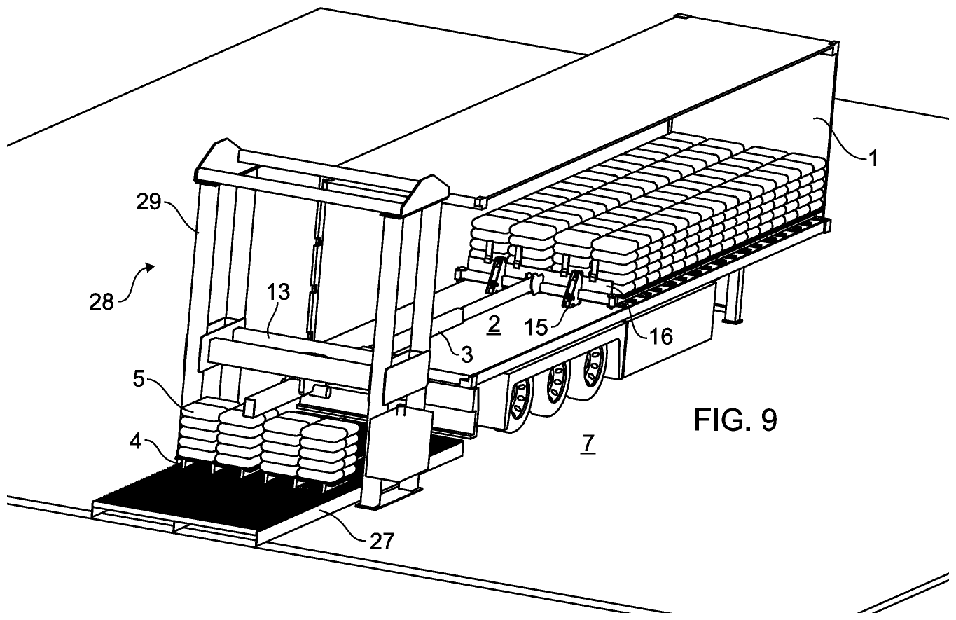

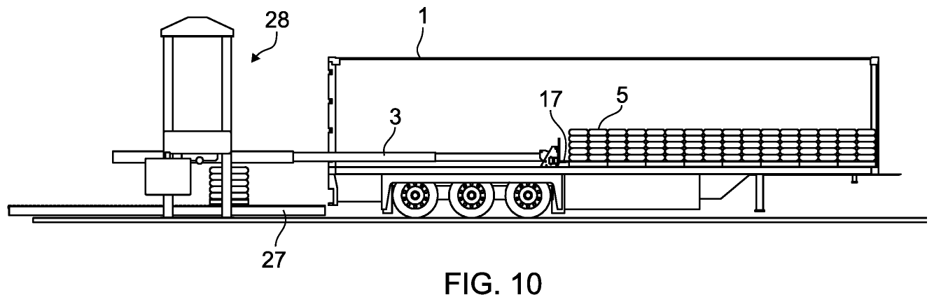

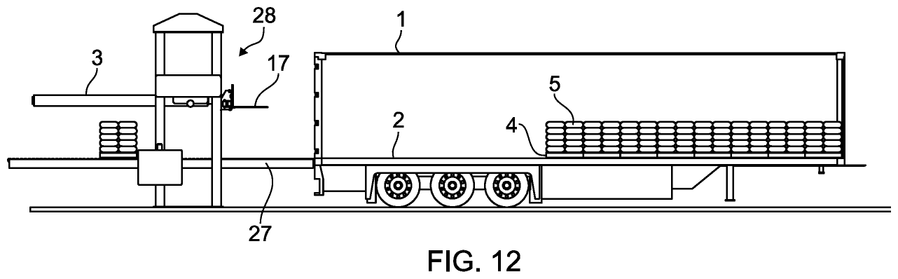

FIGS. 9-12 show an apparatus capable of flow through unloading and loading. This apparatus comprises a parallel transporter 27 set parallel to the loading dock 7 and the trailer placed therein. The parallel transporter 27 is adjustable in height. The chassis of the apparatus is a pillar frame 28 comprising four pillars 29 set two apiece on the opposite sides of the parallel transporter 27. The support frame 13 is formed of two horizontal beams extending between the opposite pillars 29. The support frame is configured to be moved vertically on the pillars 29. The apparatus operates otherwise in similar way as described above, but forwarding the goods is different. In FIG. 9 a set of pallets are set on the parallel transporter 27 and the parallel transporter is lowered to its lowest position for transporting the pallets 4 forwards. The telescopic arm 3 is extended inside the transport unit 1 to pick up next set of pallets 4. FIG. 10 shows this in side view.

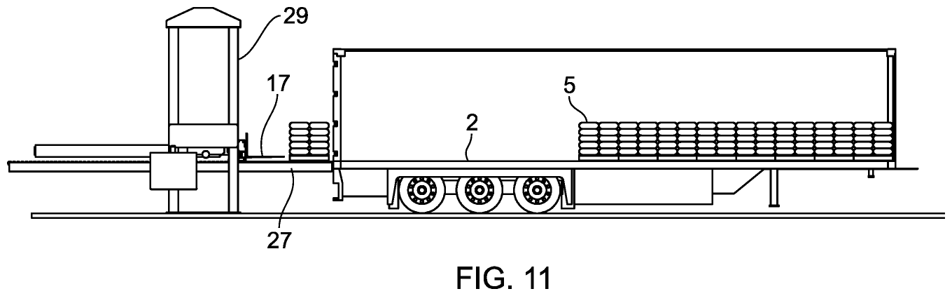

In FIG. 11 the parallel transporter 27 is in its highest position and pallets 4 are set thereon. Now, the parallel transporter 27 can be lowered as in FIG. 9 or the telescopic arm 3 can be lifted up on the pillar frame 28. This type of configuration allows forwarding the pallets on different levels. The parallel transporter 27 may be mounted on a scissor frame or set to travel on rail on pillars. The above operating alternatives may be used both in same apparatus or separate configurations.

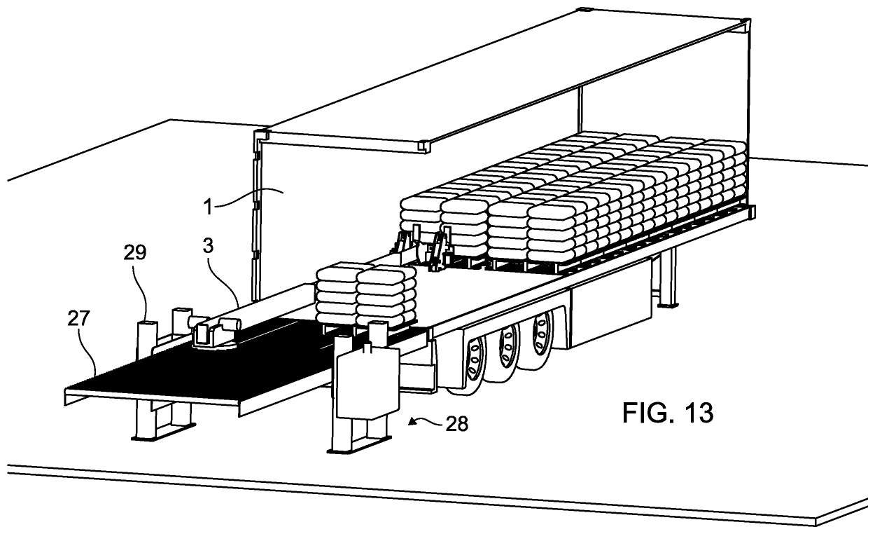

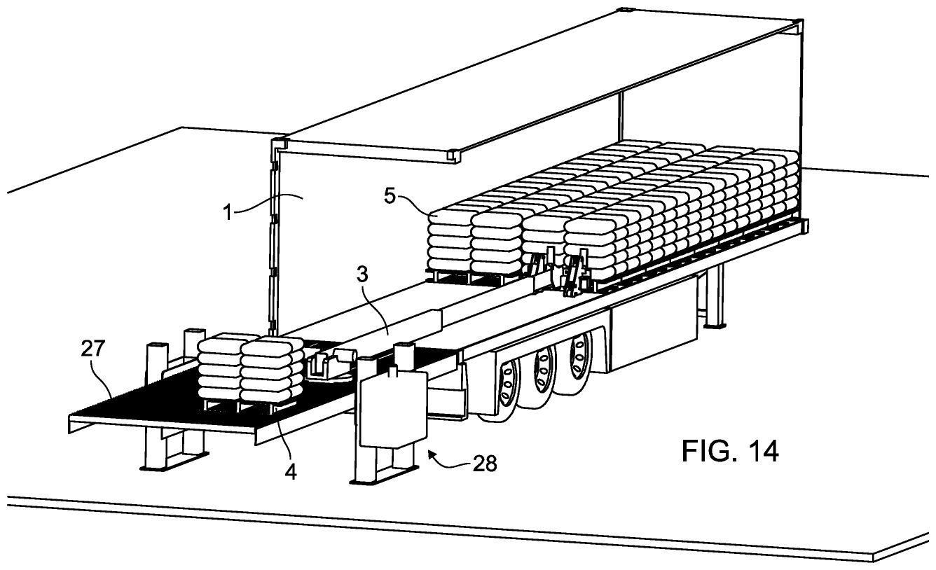

FIGS. 13 to 16 illustrate an apparatus for picking up individual pallets 4 from separate rows of pallets 4. In this apparatus, the support frame 13 is configured to be movable crosswise in relation to the parallel transporter 27. The support frame 13 extends through the parallel transporter 27 and the movement may be provided by a transfer frame set under the parallel transporter 27. In this apparatus a pillar frame 28 is used to support both the parallel transporter and the support frame 13.

The parallel transporter may be a roller track or two parallel transporters can be used side by side. If for example a belt transporter is used, it is necessary to provide caps for the support frame 13 and construct the transporters accordingly. During operation a first pallet 4 is removed from the transfer unit and left on the parallel transporter 27 (on the right side in FIGURES). The telescopic arm 3 is moved sideways. Now, the first pallet 4 is moved onwards on parallel transporter 27 and a second pallet is picked from another row inside the transport unit (FIG. 13). Next, the telescopic arm and support frame is moved sideways again to pick a pallet from another row.

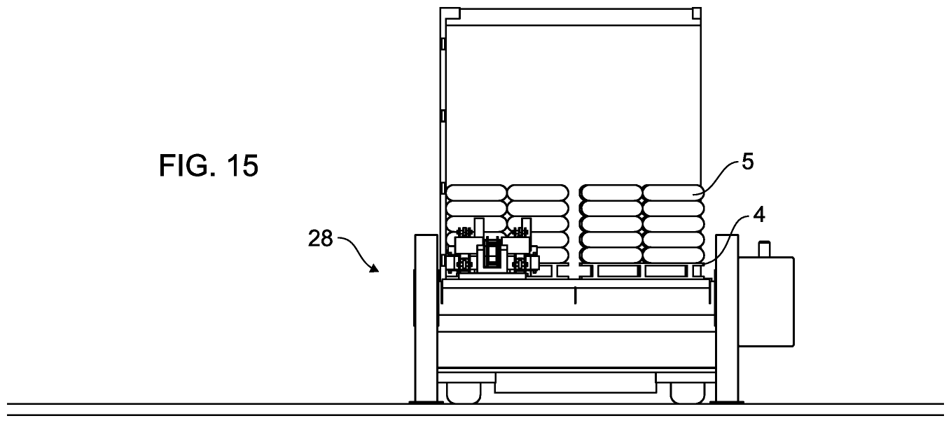

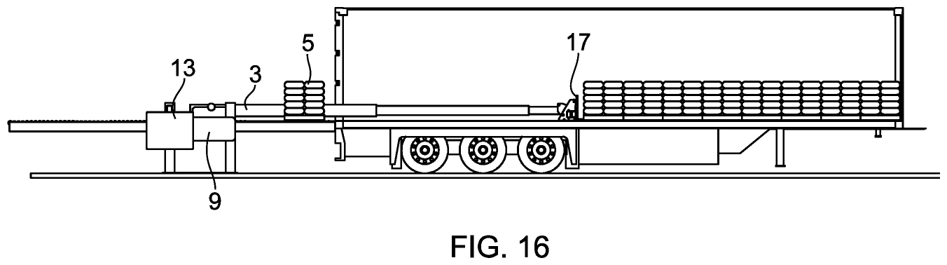

FIG. 15 is a view towards transfer unit and FIG. 16 is a side view of the previously described apparatus.

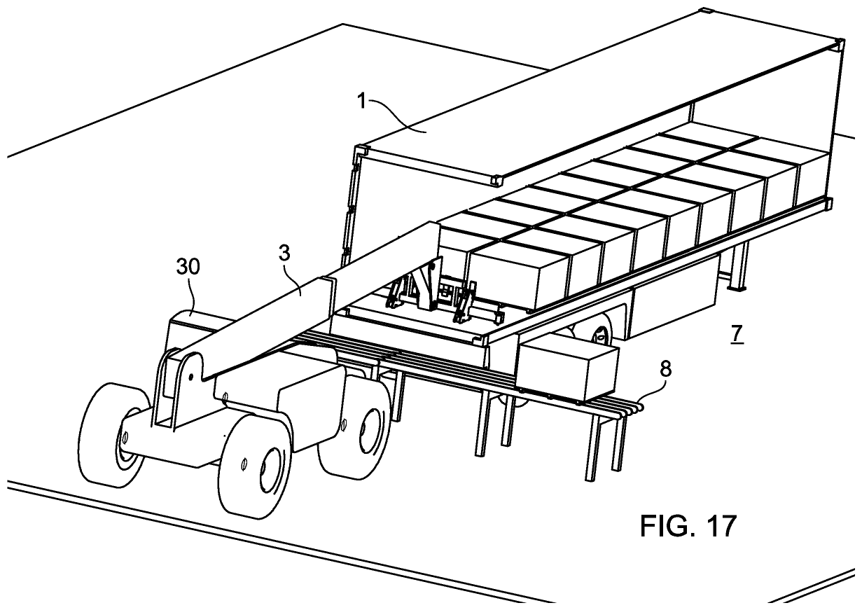

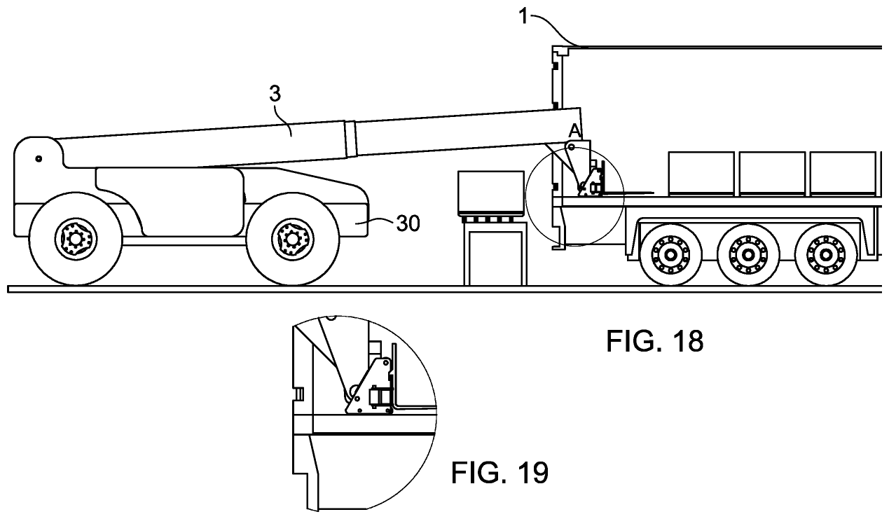

FIGS. 17-19 show the unloading/loading apparatus utilizing a telehandler 30. The operation principle and construction of using wheels 19 to support forks and load on the floor of the transfer unit is similar as in previously described examples. Now only the telescopic arm is the telescopic arm 3 of the telehandler and frame parts are formed of chassis of the telehandler.

One further feature includes mounting the telescopic arm on a rotatable support frame. This type of apparatus is capable of moving pallets from the transport unit on either side of the rotation point and even behind the rotation point. In such case the forwarding, conveyors or transporters may be positioned freely. There may be also rigid points around the rotation point on which pallets or other loads can be set for further pickup. In this way, pallets having different goods can be effectively separated.

The forks may include joints of hinges to allow tilting the spikes of the forks upwards towards the frame. This is useful if the apparatus is used as a pusher. The forks ma have various designed depending of loads and pallets they are used to handle. The forks may be replaced by grippers for specific goods, such as rolls or boxes or a lift arm can be used, for example for picking large sacks. A camera may be positioned at the extending end of the telescopic arm at a suitable place to give information to an operator or even an automation system. The electric, hydraulic or pneumatic power may be provided by operators system or an independent unit may be provided in the apparatus.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The invention can be used in various types of goods handling.

### REFERENCE SIGNS LIST

1 transport unit
2 floor
3 telescopic arm
4 pallet
5 goods
6 wall
7 unloading/loading dock
8 transverse transporter
9 chassis
10 adjustment cylinders
11 legs
12 transport wheels
13 support frame
14 tilt axle
15 frame
16 carriage
17 fork
18 hook
19 wheel
20 rail
21 lifting mechanism
22 operation cylinder
23 chain
24 pulley
25 guide rollers
26 mast
27 parallel transporter
28 pillar frame
29 pillar
30 telehandler

### CITATION LIST

### Patent Literature

CN 206051458
CN108017021
CN106957033

1. An apparatus for unloading/loading a transport unit, comprising a frame, a carriage mounted on the frame and load handling elements for lifting a load and a rolling support mounted on the frame, the rolling support being configured to provide rolling support for the frame on two locations spaced apart from each other.

2. The apparatus according to claim 1, further comprising an actuator attached to the frame for providing a linear movement for the apparatus.

3. The apparatus according to claim 1, wherein the elements for lifting the load comprises at least two forks mounted adjustably on the carriage so that the locations of the forks on the carriage are adjustable.

4. The apparatus according to claim 1, wherein the rolling support comprises wheels or caterpillar tracks.

5. The apparatus according to the claim 4, wherein the wheels or tracks are provided with an actuator for providing traction.

6. The apparatus according to claim 3, wherein the locations of the forks on the carriage are adjustable hydraulically, pneumatically or electrically.

7. The apparatus according to claim 3, wherein the forks are telescopic.

8. The apparatus according to claim 3, wherein the forks comprise a hinge configured to enable tilting of forks upwards towards the carriage.

9. The apparatus according to claim 1, further comprising a lifting mechanism for lifting the load by hoisting the elements for lifting the load.

10. The apparatus according to claim 2, wherein the actuator for providing the linear movement is a telescopic arm.

11. The apparatus according to claim 10, wherein the telescopic arm is mounted on a support frame that is movable at least in a direction sideways to direction of movement of the telescopic arm.

12. The apparatus according to claim 10, wherein the telescopic arm is mounted on a support frame that is rotatable around a mounting point.

13. The apparatus according to claim 2, wherein the telescopic arm is a telescopic arm of a telehandler.

14. The apparatus according to claim 1, wherein the carriage is mounted on the frame by a mast comprising a lift actuator for raising and lowering the carriage.

15. The apparatus according to claim 1, wherein the frame comprises side guides.

16. The apparatus according claim 1, wherein the mounting position of the telescopic arm forms a first reference point, an unloading/loading dock is positioned in the direction of the movement of the telescopic arm and a transverse transporter is positioned between the first reference point and the unloading/loading dock.

17. The apparatus according to claim 1, further comprising a pillar frame having a plurality of pillars, wherein the telescopic arm is mounted on the pillar frame and a transporter is set between the pillars of the pillar frame.

18. A method for unloading and loading a transport unit, wherein an unloading/loading apparatus is forwarded into a transport unit supported by a rolling support providing rolling support on two locations spaced apart from each other, lifting the load with elements for lifting the load of the unloading/loading apparatus and withdrawing the load supported by the rolling support.

19. The method according to the claim 18, further comprising forwarding the unloading/loading apparatus into a transport unit by a linear movement of a telescopic arm.

20. The method according to the claim 19, further comprising:
retrieving a pallet from the transfer unit,
setting the pallet on a parallel transporter,
increasing the vertical distance between the parallel transporter and the telescopic arm, and
forwarding the pallet.

21. The method according to the claim 19, further comprising:
retrieving a pallet from the transfer unit,
setting the pallet on a parallel transporter,
moving the telescopic arm sideways in relation to the parallel transporter, and
forwarding the pallet on the parallel transporter.

22. The method according to the claim 19, further comprising:
retrieving a pallet from the transfer unit,
rotating the telescopic arm, and
setting the pallet on a pickup point.
